(19) United States
(12) Patent Application Publication
(10) Pub. No.: US 2011/0015961 A1
(43) Pub. Date: Jan. 20, 2011

(54) Method and system for an event scheduler

(76) Inventor: Danny Chan, New York, NY (US)

Correspondence Address: DANNY CHAN, 20 Monroe Street Apt. Li-10, New York, NY, 10002, US

(21) Appl. No.: 12/460,201

(22) Filed: Jul. 15, 2009

(51) Int. Cl. G06Q 10/00; G06F 15/16; G06Q 50/00

(52) U.S. Cl. 705/9; 709/206

(57) ABSTRACT

The present invention relates to a computer system and method for providing an interactive method for automatically scheduling and event such as a conference or entertainment event including determining availability for each of a plurality of invitees participants and selecting a date and time for the event upon the availability of each of the plurality of invitees. The method also includes arranging the invitees into different sets of participants to best accommodate invitees having the same event, date, time, location and price preferences. selecting a mode of communication compliant with an invitees receiving device; sending the invitees an event having one or more associated parameters based upon a template; and receiving availability from the invitees for each event having parameters; matching the event to the invitees availability for the event; automatically initiating the event by calendaring or booking to preserve the position at the event for the invitee.

### FIELD OF INVENTION

The invention relates generally to a method and system, as implemented by a software program on a computer system, mobile device or hand held device, for scheduling events in real-time and real-time tracking and accounting of individuals in responding to the events without the need to go through multiple rounds of coordination and discussions.

### BACKGROUND

Communication technology is advancing at a rapid pace. However, rather than a convergence in the technologies available to receive communications there has actually been a proliferation of technologies, e.g., PCs, tablet PCs, PDAs, cell phones. In addition to the hardware and software systems that operate these devices, applications have expanded such that individuals can receive communications from services such as facsimiles, instant messages, telephone calls, Short Message Service (SMS) messages, Twitter, traditional email TCP/IP protocols, etc. Short Message Service (SMS) is a communication service standardized in the GSM mobile communication system, using standardized communications protocols allowing the interchange of short text messages between mobile telephone devices.

When scheduling events it is particularly important to be able to communicate across device technologies, as well as application technologies. Accordingly, it would be beneficial to provide a system that actively supports efficient event scheduling among invites having diverse modes of communication.

The prior art does not address the need for a method and system that operates in a short hand manner to schedule events, nor systems that autonomously work across different communication protocols. Mandalia et al. U.S. published patent application 20070033251 describes a method of automatically conducting a conference by determining availability for each of a plurality of conference participants and selecting a date and time for the conference based upon the availability of each of the plurality of conference participants. The method further can include automatically initiating the conference among the conference participants on the date and at approximately the time for the conference, wherein communication with an invitee is established is based upon context information that associates the invitee with a type of event. However, the '251 published patent application does not include a template of short hand notation that defines the events for which a calendaring of individuals is desired. Additionally is does not provide for notification of the event by automatically determining the technology of the recipient's receiving device.

Anglin et al. U.S. published patent application 20090112984 includes receiving a meeting invitation request from a user, wherein the meeting invitation includes a set of attributes and analyzing the set of attributes of the meeting invitation request and an availability probability process. The present invention is not directed towards an analysis of the probability of availability and rather depends on user-defined parameters that specify their availability for different events. Liversidge et al. U.S. published patent application 20020076025 is a collaboration services suite adapted to support a plurality of integrated telecommunications services accessed by geographically dispersed team members that are automatically set up by the collaboration services suite in response to request messages generated by the VTE client when a team member initiates a communications session request using the GUI. In this present invention the entire scheduling process may be achieved autonomously.

Horvitz, et al. U.S. Pat. No. 7,305,437 describes a system and method for infer the time until a user will be available for communications, given evidence about such observations as time of day, calendar, location, presence, and activity. The '437 patent does not include a template of short hand notation that defines the events for which a calendaring of individuals is desired.

### SUMMARY OF THE INVENTION

The present invention relates to a real time method as implemented on the computer system for providing the interactive scheduling an event including determining availability for each of a plurality of event participants and selecting a date and time and resources limits for the event upon the availability of each of the plurality of participants.

In the present invention the invitee/user is informed of the MER (that is information such as by way of example, name, date, time, price and location regarding calendaring for among other things, meetings, events and reservations). The pulling feature of the invention, wherein data are pushed from a source or user to a destination user, obviates the need to constantly update a database it to make sense of what and when events are happening.

The inventive method aggregates all the needed information from all invitee/users so that the organizer needs only to check status at the end of a cut off time.

More specifically, an aspect of the present invention relates to a method as implemented on a computer system for scheduling an event to include: selecting a mode of communication compliant with an invitees receiving device; sending the invitees an event having one or more associated parameters based upon a template; and receiving availability from the invitees for each event having parameters; matching the event to the invitees availability for the event; automatically initiating the event by calendaring or booking to preserve the position at the event for the invitee.

An aspect of the method further includes establishing a communication with each invitee.

The method further includes sending a notification to each invitee after obtaining a confirmation of an event booking.

The method further includes communication with an invitee based upon context information that associates the invitee with a type of event.

The method further includes notifying each of the plurality of invitees of the date and time of the event via the mode of communication compliant with an invitees receiving device.

The method also includes arranging the invitees into different sets of participants to best accommodate invitees having the same event, date, time, location and price preferences.

The method also includes the ability to email selected dates and calendars to an individual, obviating the need to have access to a calendar application. A “virtual calendar” thus is established that may be used as a standalone or be updated to and from other calendar systems, connected to the method and systems as further described herein.

An object of the present invention is to reduce communication among parties desirous of participating in an event.

It is a further object of the invention that unlike corporate sites and internet sites specifically for organizing MERs one generally has to be a member of a closed group, whereas in the present an invitee or user of the system and method need not have to be a register member of the group.

Yet another object of the invention is to facilitate the organizing of events by creating a shorthand that reduces the typing required to code the MER, which will be shown to enhance usability of small screen devices wherein a user employs texting, sms, or quick communications.

### BRIEF DESCRIPTION OF THE DRAWINGS

Understanding of the present invention will be facilitated by consideration of the following detailed description of the preferred embodiments of the present invention taken in conjunction with the accompanying drawings wherein:

FIG. 1 is a block diagram of a system for scheduling and event according to an embodiment of the present invention;

FIG. 2 is a block diagram of a system for scheduling and event according to an embodiment of the present invention;

FIG. 3 is a state diagram of a system for scheduling and event according to an embodiment of the present invention;

FIG. 4 is a flow chart of a method for scheduling and event according to an embodiment of the present invention;

FIG. 5 is a flow chart of a method for scheduling and event according to an embodiment of the present invention.

FIG. 6 is a flow chart of a method for scheduling and event according to an embodiment of the present invention;

FIG. 7 is a flow chart of a method for setting up parameters according to an embodiment of the present invention;

FIG. 8 is a flow chart of a method for setting up templates according to an embodiment of the present invention;

FIG. 9 is a flow chart of a method for setting up templates according to an embodiment of the present invention;

FIG. 10 is a flow chart of a method for setting up templates according to an embodiment of the present invention;

FIG. 11 is a flow chart of a method for setting up templates according to an embodiment of the present invention;

FIG. 12 is a flow chart of a method for scheduling according to an embodiment of the present invention;

FIG. 13 is a flow chart of a method for setting up templates according to an embodiment of the present invention;

FIG. 14 is a flow chart of a method for scheduling and calendaring according to an embodiment of the present invention;

FIG. 15 is a flow chart of a method for scheduling and calendaring according to an embodiment of the present invention;

FIG. 16 is a flow chart of a method for scheduling and calendaring according to an embodiment of the present invention;

FIG. 17 is a flow chart of a method for scheduling and calendaring according to an embodiment of the present invention.

### DETAILED DESCRIPTION

It is to be understood that the figures and descriptions of the present invention have been simplified to illustrate elements that are relevant for a clear understanding, while eliminating, for the purpose of clarity, many other elements found in computing systems and methods of making computations. Those of ordinary skill in the art may recognize that other elements and/or steps may be desirable in implementing the present invention. However, because such elements and process steps are well known by those of ordinary skill in the art, and because they do not facilitate a better understanding of the present invention, a discussion of such elements and steps is not provided herein.

In what follows, an event can be a meeting, a group activity, a commercial or social transaction, a reservation, or anything that requires an action from one or more individuals. In this disclosure, for the sake of brevity, the event is also variously referred to a MER, which generally relates to the types of calendaring that customarily takes place in a social or commercial setting, e.g., a meeting, an event, or a reservation.

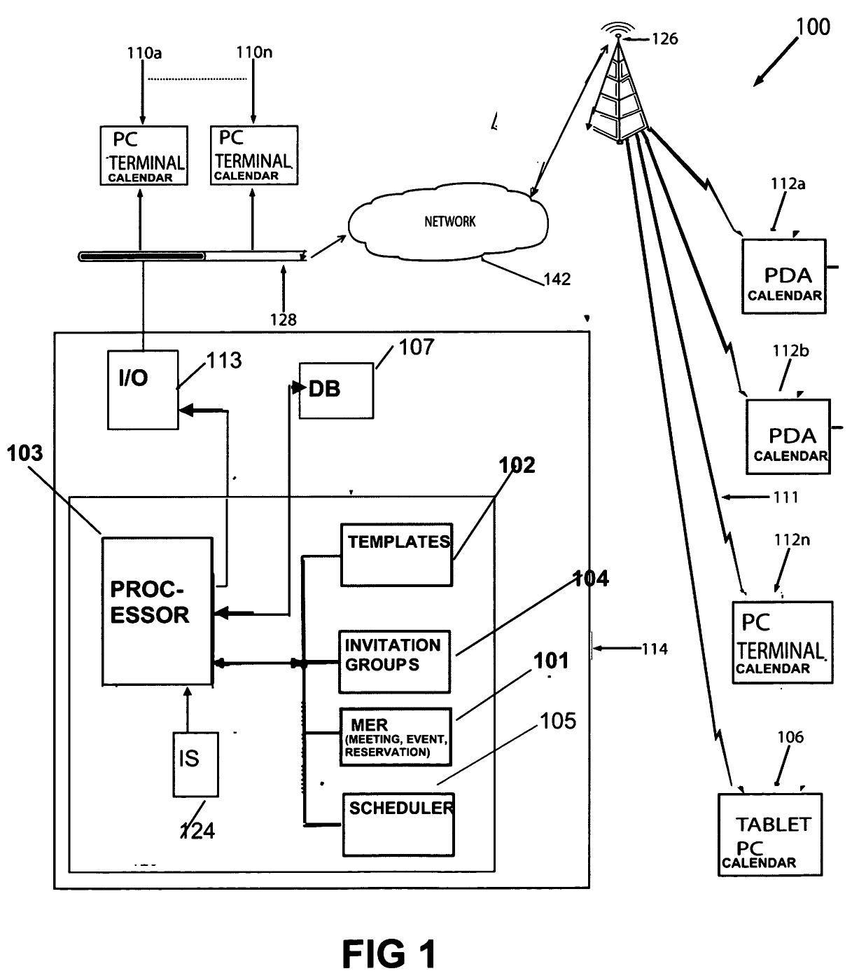

FIG. 1 of the present invention relates to a computer system 100 that provides for an interactive for scheduling an event including determining availability for each of a plurality of event participants, including: a computer 114 having a processor 103 for scheduling MERs and an associated database 107 having in one embodiment pre-stored invitee/user calendars, and mobile PDAs 112a-112n, and one or more tablet computers 106 operable under one or more operating systems having application programs for registering individuals having access, and for scheduling events and communicating with diverse technologies with varied communication protocols. Certain of these devices are known under various tradenames and trademarks such as Blackberry, Iphone, and PALM, etc. Computing environment 100 having computer 114 and processor 103 provides the back-end integration framework necessary for providing functions including, but not limited to, mobile personal information management (PIM), electronic mail synchronization, and access to Web-based and other content. Within such messaging systems, the application programs for registering individuals having access, and for scheduling events includes selecting invitees according to a profile associated with the invitees targeted device as well as a profile of availability and other event preferences. For example, a profile can specify that messages sent through the messaging system to the target user should be forwarded as electronic mails, as text messages, or through such services as Twitter or other forms of instant messages. Those of ordinary skilled in the art of engineering and programming these devices understand the technical requirements for a process for creating profiles and the protocols required to send through a messaging system to a target user as electronic mails or as text messages through conventional email services, mobile phone systems, text messaging systems utilizing such services as Twitter, Facebook, instant messaging or other forms of communications.

In one embodiment of the invention shown in FIG. 1, system 100 has at least one computer 114 to independently service multiple applications and multiple invitee users including associated data terminals 110a-n that may service events, various Ethernets 128, a communication network 111, and mobile peripheral devices 112a-112n, such as personal data assistants. The computer 114 and database 107 may operate under the control of an SQL server. All of these later elements are in communication with respective CPUs to facilitate the operation of the system 100. Additionally computer 114 has therein information as name, date, time, price and location regarding meetings, events and reservations, referred to as “MER” 101, sets of Invitation groups 104, templates 102 and scheduling software 105. The MER 101 may include several sets of parameters that define a MER. For example a Broadway show may be performing at different times and at different prices, each of which would be considered a separate MER. Additionally in the example provided, one Broadway show may have one set of templates while another Broadway show may have a different set of templates depending on the organizer's preferences. Templates can be reused, modified, or newly created.

The computer 114 additionally has Internet connectivity generally through an input/output device 113. Device 113 operates in conjunction with a web information services module 124 associates a potential invitee to a given technology and communication application. It is capable of operating in various environments such as Ethernet, Bluetooth, NMT, GSM, UMTS, HTUP, SOAP and TCP/IP. By way of further example an invitee user of PDA device 112a may incorporate a standard TCP/IP protocol for transmitting and receiving text messages. If the PDA device is a Blackberry operating in twitter mode, the web information services module 124 associates a potential invitee to a given technology and communication application to provides the protocol necessary for processor 103 and the input/output device to communicate bi-directionally with that particular invitee. It is therefore not necessary that each remote device 112a-112n have the same operating system, nor central processing unit (CPU) type.

The communications input/output 113 may have minimal processing capability itself, serving primarily as a communications router for establishing a corresponding link 111 with the computer 114. A variety of communications transports and protocols may be part of the system by way of example, but not limited to: Ethernet, Bluetooth, NMT, GSM, UMTS, HTTP, SOAP and TCP/IP or any other communication means as developed in the future. The foregoing acronyms are well known to those of ordinary skill in programming communication devices for telephone systems, wireless, satellite and Internet application. In one embodiment of the invention each of the machines 110a-n and computer 114 has an operating system such as the Microsoft Windows XP.®., Linux.®., and Macintosh OSX.®., or any third party operating system. The operating system in each of the user machines need not be the same as long as it supports a web browser or other application to access the wide area network (WAN) or the Internet, or texting and sms, and additionally supports the execution of codes to facilitate the intended media functions of the invention.

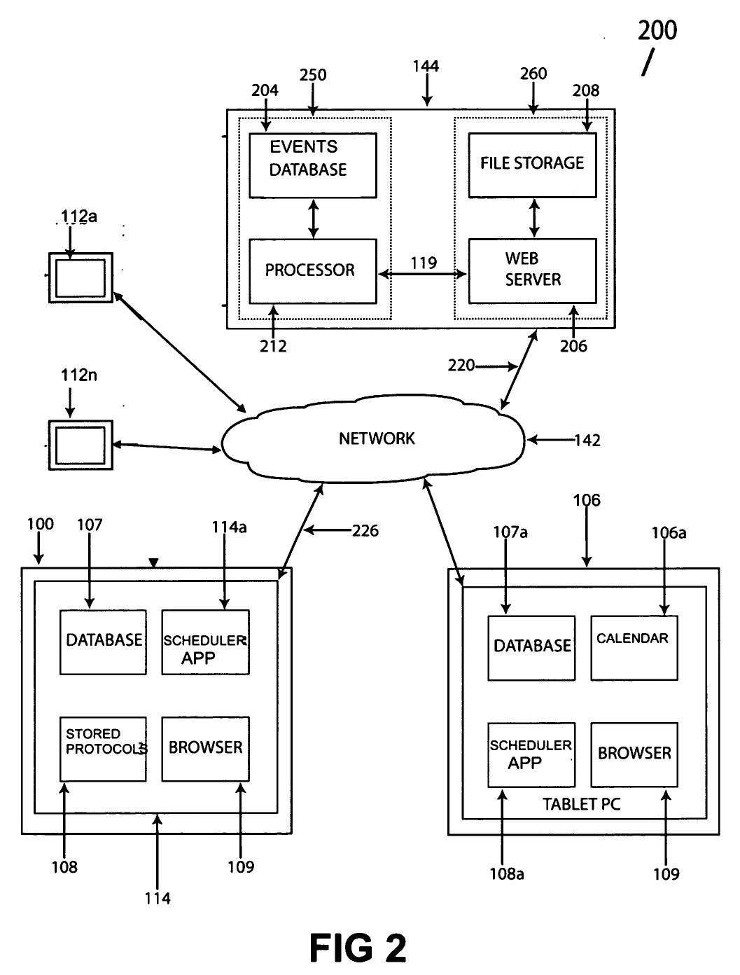

The mobile devices 112a-112n are used to receive event information and determine if the invitee associated with the respective device is able or desires to attend the event. It processes the information either automatically based upon preset information or through a combination of preset information and user inputs to respond back to computer 114 as to the availability of the invitee regarding the event in question. The mobile devices 112a-112n each may include application software, which includes executable software modules that assists in scheduling events for the invitee. It communicates with the web application service 124 and scheduler 105 as hosted by the computer 114 over a secured or unsecured wireless network such as networks 126, 111. A web management application program (not shown) included in computer 114 software allows communication with PC terminals 110 that may download events form sources such as commercial event processors (Ticketmaster, other conference schedulers, etc.) and additionally serve system monitoring, configuration, and administration of the mobile units along with system reporting, through the facility of a browser 109 (FIG. 2). The system 100 allows also dynamic allocation of unit resources since the operation can be reassigned from the console. For instance the system 100 can allow the administration of operation of the method of invention herein to operate from the mobile devices 112a-112n including tablet PC 106.

Again referring to FIG. 1, all services as contained within the system 100 are equipment selected from a list to include computer 114, PC terminals 110a-110n, PDAs or Intelligent Electronic Device (IED) 112a-112n. The machines 110a to 110n communicate with each other and the computer 114 through the network 128.

FIG. 2 illustrates system 200 incorporating the system 100 the latter configured to communicate with server 144. Computer 114 communicates with server 144 that provides ancillary management services for not only one such scheduling system 100, but also a plurality of scheduling systems.

In FIG. 1 and FIG. 2 each of the computers (i.e., 114, 110a-110n, PDAs 112a-112n, tablet PC 106 includes a CPU, such as one or more conventional microprocessors and one or more supplementary co-processors such as math co-processors. The processors are typically in communication with a communication port through which the processor communicates with other devices such as other servers, user terminals or devices. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices.

The processors are also in communication with one or more data storage devices. The data storage devices may comprise an appropriate combination of magnetic, optical and/or semiconductor memory, and may include, for example, RAM, ROM, flash drive, an optical disc such as a compact disc and/or a hard disk or drive. The processors and the data storage devices each may be, for example, located entirely within a single computer, PDA, IED or other computing device; or connected to each other by a communication medium, such as a USB port, serial port cable, a coaxial cable, a Ethernet type cable, a telephone line, a radio frequency transceiver or other similar wireless or wired medium or combination of the foregoing.

The data storage devices may store, for example, (i) a program (e.g., computer program code and/or a computer program product) adapted to direct the processor in accordance with the present invention, and particularly in accordance with the processes described in detail hereinafter; (ii) a database adapted to store information that may be utilized to store information required by the program. The database includes multiple records, each record including fields specific to the present invention.

The program may be stored, for example, in a compressed, an uncompiled and/or an encrypted format, and may include computer program code. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as alternative steps of invention. The computer program code required to implement the above functions (and the other functions described herein) can be developed by a person of ordinary skill in the art, and is not described in detail herein.

The term “computer-readable medium” as used herein refers to any medium that provides or participates in providing instructions to the processor of the computing device (or any other processor of a device described herein) for execution. The term “computer-readable medium” also includes a machine-readable storage, having stored thereon a computer program having a plurality of code sections executable by a machine for causing the machine to perform steps in an electronic process. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Referring to FIG. 2, the corporate system 200 servers 144 may include a data storage device such as file storage 208, which includes a hard magnetic disk drive, optical storage units, CD-ROM drives, or flash memory. Data storage devices contain databases such as database 204 used in processing transactions and/or calculations in accordance with the present invention, including at least a user subscriber database and a user content database. In one embodiment, database software creates and manages these databases. System 200 related calculations and/or processing algorithms of the present invention are stored in storage device and executed by the corresponding CPU.

Computer system 250, 260 of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc.).

The system 200 comprises of a host 212 in synchronous communication with one or more user machines. In an embodiment, the host is a server in communication with an events database 204; where the host is also in communication with a web server 206 that communicates with a file storage 208. The database 204 can be in a separate server, or can be part of the host server 212 within the same computer system 250. Similarly, the web server 206 and the file storage 208 can be separate units or can be integrated into a server 260. The physical location of the database 204, file storage 208 and the method of writing the machine executable codes being integrated into the host server 212 is not important to the invention as long as the functions are accessible to the host 212 and to the user machines.

In an embodiment, each of the computers has an operating system respectively, such as the Microsoft Windows XP.®., Linux.®., and Macintosh OSX.®., or any third party operating system. Macintosh is a registered trademark of Apple, Inc. The operating system in each of the computers need not be the same as long as it supports a web browser or other application to access the internet or wireless connections and supports the execution of codes to facilitate the intended media functions of the invention. The network 220 and the corresponding links 214, 218, 119, 111 and 128 are part of a Wide Area Networks (WAN), Local Area Network (LAN) through Ethernet connections or wireless connections. Yet in other embodiments, the network and the links can be Local Optical Networks (LON), direct fiber optic links, or direct terminal connections or plain old telephone service (POTS). In all forms of link communications within the network 142, the communications can be enhanced with known encryption protocols to improve security.

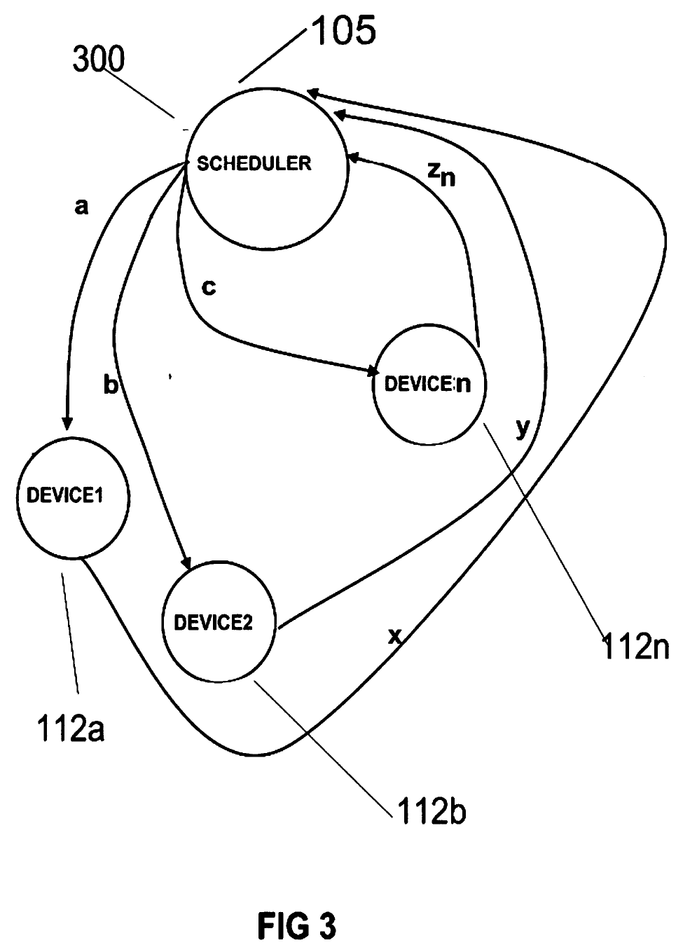

FIG. 3 represents a state diagram wherein a scheduler 105 receives input z from device 112n in the form of a request to schedule an event. The request comes in the form of a template 102 (See, FIG. 1) to be further described below. The scheduler broadcasts a, b, c the MER 101 (FIG. 1) details based on user communications preferences as stored by way of example in the web information services module 124 that associates a potential invitee to a given technology and communication application. Through the receiving device receiving the broadcast, such as device 1, 112a, a user communicates, times, dates and the number of units (such as number of seats at an event) in addition to the criteria for administration to the scheduler via communication's channel x. In the case of devices 112b through 112n, each communicates on respective channels y through zₙ.

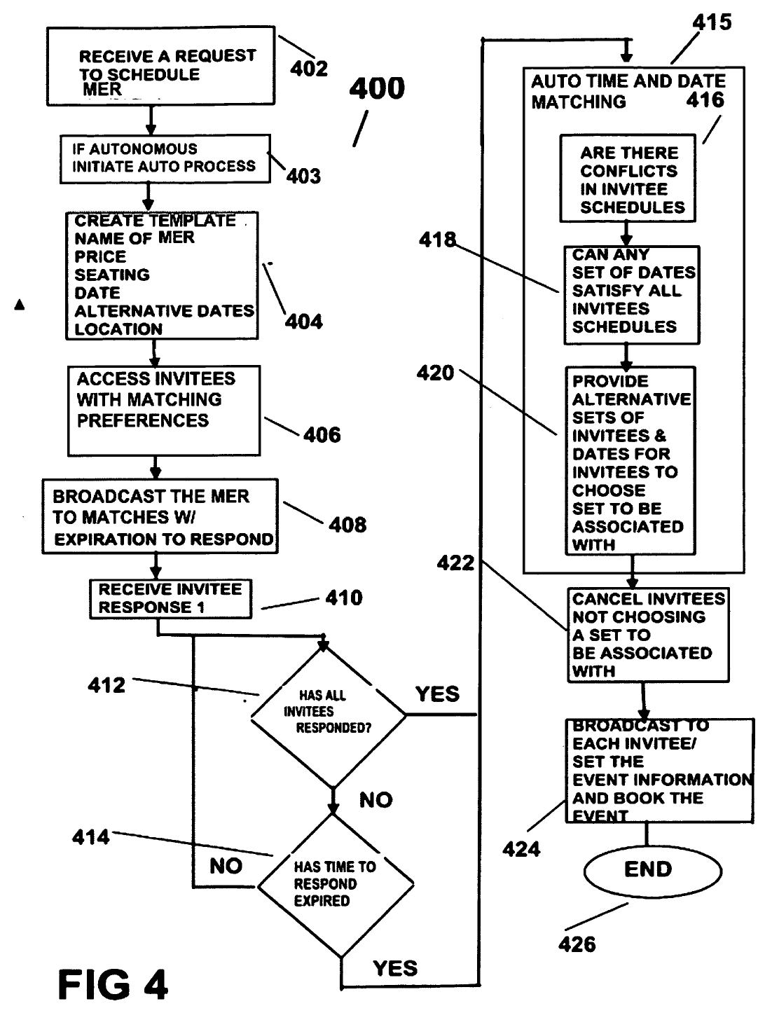

Ownership of the organizational effort in scheduling may include anyone within an interested group. Additionally, multiple group organizers can use one calendar within the application to create events. In one embodiment of the invention all event information regarding the MER is sent to the application program to process via email, text, etc and thus the scheduling is autonomous, i.e., no human interaction is required to setup the organizing of an event. FIG. 4 in conjunction with FIG. 1, illustrates one non limiting embodiment of a method 400 of the invention as implemented on a computer system for providing scheduling an event that includes: receiving a request 402 from a user of the system 100 (FIG. 1) to create a meeting/event or reservation referred to above as MER 101 (FIG. 1). The system through an autonomous administrator 403 or a human administrator selects or creates a template of the MER 404 and then accesses a file of the invitee/users 406 from a database of invitee groups 104 of the system 100 (FIG. 1) in order to broadcast the MER to the invitee/users details based upon user preferences as determined from user communication preferences 124 (FIG. 1), and whereupon the invitee/user receives 410 the broadcast. If the invitee/users interest and availability of the MER are pre-stored in the database 107 the matching of the MER with the invitee/user is automatically provided by the system 100 scheduler 105 (FIG. 1). The scheduler 105 matches the times and/or quantities requested from invitee users pre-stored in database 107. However, if the invitee/users interest and availability of MER is not pre-stored in the database 107 then the system 100 and scheduler 105 must receive 410 responses from these invitee/users that express interest in the MER after receiving the broadcast. In FIG. 4 the system 100, scheduler determines if in as a response from all the necessary invitee/users 412. It also determines if the time to respond has expired 414. When either the all the necessary invitee/users have responded 412 or the time has expired 414, then the scheduler 150 (FIG. 1) matches the MER times and quantities from the invitees/users either pre stored in database 107 or responding 410.

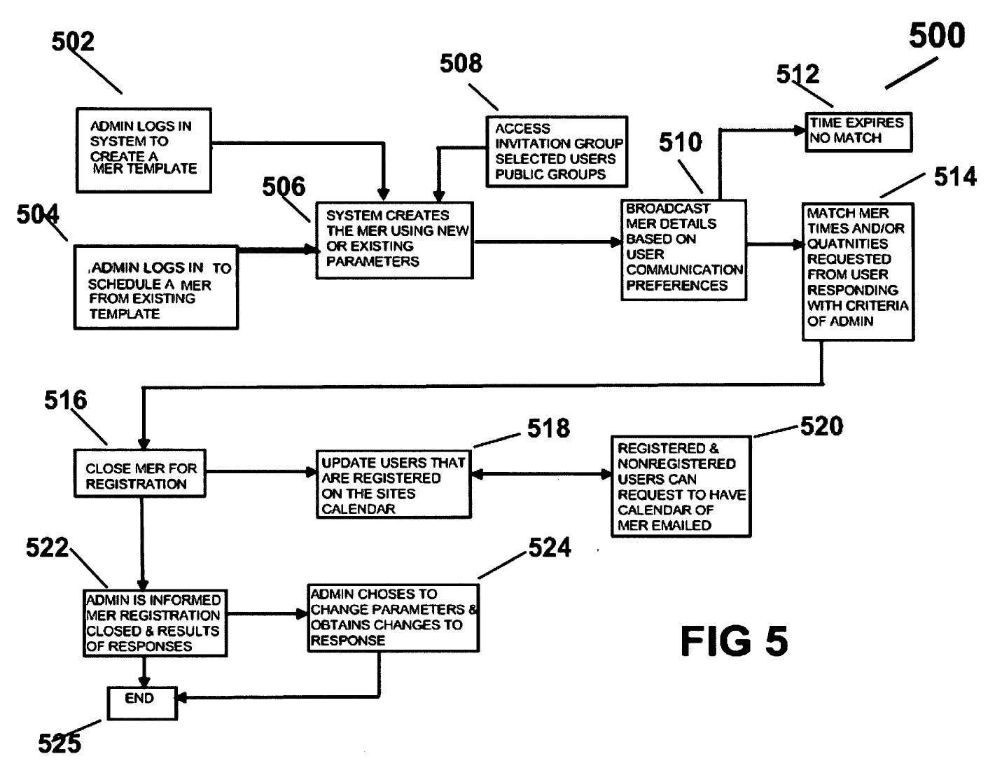

With reference again to FIG. 4 and FIG. 1, in one alternative embodiment, the scheduler 105 determines whether any set of parameters of the MER 101 matches the preferences of the invitee/user or there are conflicts. By way of example, the preferences expressed by an invitee are matched in a process 415 that includes determining conflicts 416 such as to time and date, among other types of conflicts. The scheduler 105 determines if any set of MER parameters satisfy all invitee/user preferences 418. In yet another alternative embodiment, if the MER 101 does not match an invitee/user preference it may provide alternative sets of MER parameters 420 for invitees to choose from. If then a conflicted invitee/user does not choose an alternative MER parameter set then the invitee/user is cancelled 422 from the schedule. A broadcast is made 424 to update the invitee/users that are scheduled for the particular MER. FIG. 5 is yet another embodiment of the system and method of the present invention, wherein an administrator, either an individual or an autonomous process, initiates and performs step 502 that includes logging into system 100 resident on computer 114 in order to create a template of a meeting, event or reservation, which has been referred to a MER. The administrator may take step 504 that includes logging into system 100 resident on computer 114 in order to utilize an existing a template of a MER. In step 506 the system 100 creates the MER from a new or an existing set of parameters. In step 508 the system 508 accesses an invitation groups or public groups and associates the MER in step 506 with the groups in step 508. The invitation groups or public groups are invitees that have stored parameters specifying their preferences as to type of meeting to attend, price of an event or time and place. The system 100 through computer 114 I/O 113 and associated network 142 broadcasts the MER to the invitee/users based upon their preference parameters in a mode of communication stored in web information services module 124. The mode of communication determines the manner in which the communication is received, as for example, Twitter, Evite, Facebook, simple email, etc. Evite is a trademark of an invitation and social planning website. Twitter is a service for individuals to communicate with short messages; Twitter is a trademark of Twitter, Inc. Facebook is social communication network. Facebook is a trademark of Facebook, Inc.

A timer is set 512 upon broadcast to determine if a time for response from invitee/users to respond has expired. In step 514, the scheduler 105 matches the MER times an/or quantities or any other parameters of significance, such as price or location, with the invitee/users responding with particular criteria or requirements. When the match is complete the MER is closed 516 for registration. The administrator is informed that the registration is closed 522 along with the results of the responses. Once the registration is closed 516, the invitees/users that are registered on a particular service are updated on the sites calendar, whereby such updates are stored on database 107 for future reference. In step 520 a registered or non-registered invitee/users may request 520 to have the calendar emailed to its email address. In some devices and corresponding application systems a user may have access to the application of the device with which it is communication with to receive calendar updates. In any case step 520 includes the facility for a virtual calendar, that is one where the MER is detailed in the email or other forms of recordation and display. In step 524 an administrator may choose to change parameters and obtain responses to preferences stored on the system 100, database 107 to determine optimal time, price, user attendance, etc. for a particular MER. Once the MER is scheduled the process ends 525.

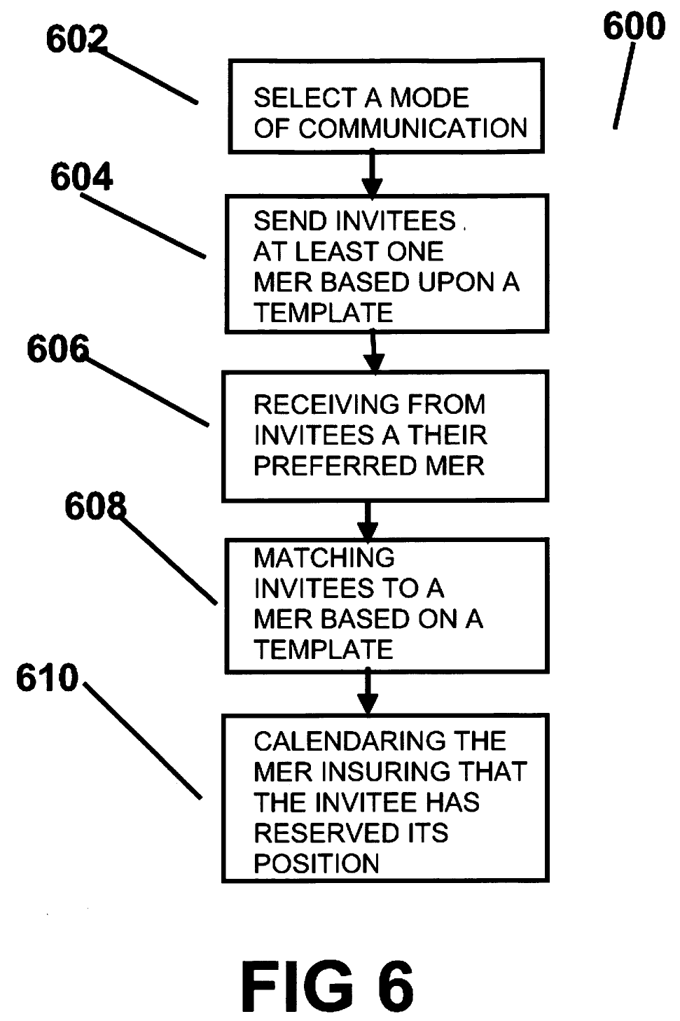

In FIG. 6, the method 600 for scheduling a MER includes: selecting a mode of communication 602 compliant with an invitees receiving device; sending the invitees an event 604 having one or more associated parameters based upon a template; and receiving availability from the invitees 606 for each event having parameters specifying preferences; matching the event to the invitees availability 608 for the event; automatically initiating the event 610 by calendaring or booking to preserve the position at the event for the invitee.

Short messaging response format facilitates responding on any communications device. This is especially desirable in the case of hand held PDAs or cell phones where ten or less mnemonics may efficiently code for a MER and thus schedule and an event.

The methods described in FIG. 4, FIG. 5 and FIG. 5 may be contained in machine readable storage, having stored thereon a computer program having a plurality of code sections executable by a machine for causing the machine to perform the steps of: creating a template having a conditional availability for each of a plurality of invitees to an event or MER; selecting a mode of communication compliant with a receiving device of each invitee; sending the plurality of invitees a communication based upon the content of the template; and receiving availability from one or more of the invitees responding to be scheduled for the event; matching the event to the invitees specific availability for the event or MER; automatically initiating the event by calendaring the position for the event for the invitee responding to be scheduled for the event or MER.

In one non-limiting embodiment, each invitee receives confirmation of the calendaring or booking to preserve the position at the event for the invitee. In another embodiment the invitee receives reminders of the MER for which it has been scheduled to attend.

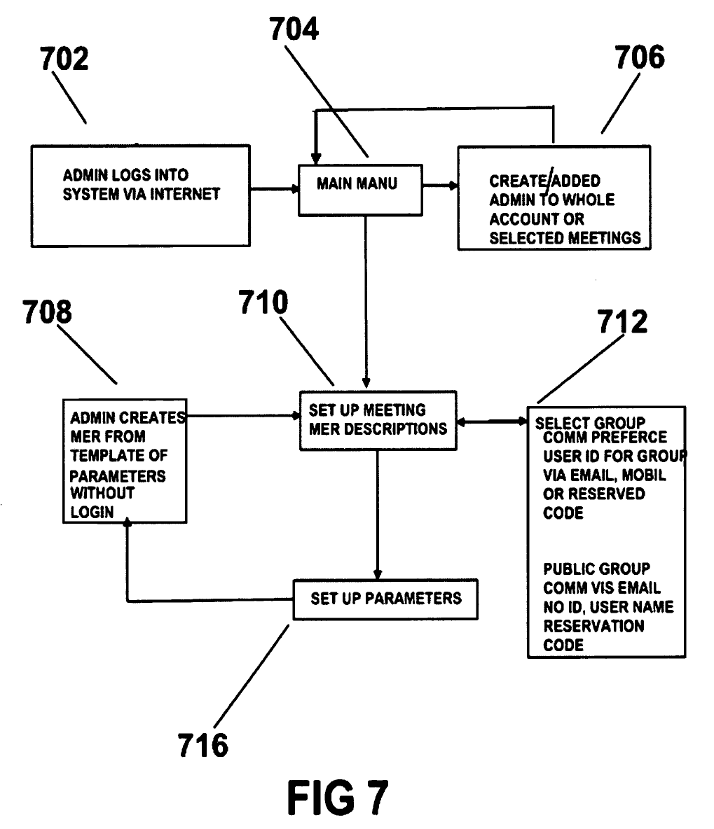

Turning to FIG. 7, in step 702 the administrator logs into system 100 via the Internet through the facility of a browser 109 (FIG. 2) and observes a main menu 704. Consistent with method 400 (FIG. 4), method 500 (FIG. 5), and method 600 (FIG. 6), by way of example, in step 706 the administrator can then create or add to an account representing an event (as for instance a conference) that may include several meetings or choose only selected meetings within an event. An action identification is associated with each MER.

In step 710 the administrator then sets up the parameters of the event or the selected meeting. In step 712 the administrator has two sets of invitees to choose from a public group or a select group. Parameters for the meeting such as to assign an action/event identification are set up in step 716 in step 708 by creating a MER from an existing template (e.g., one of a library of templates) or creating a new template.

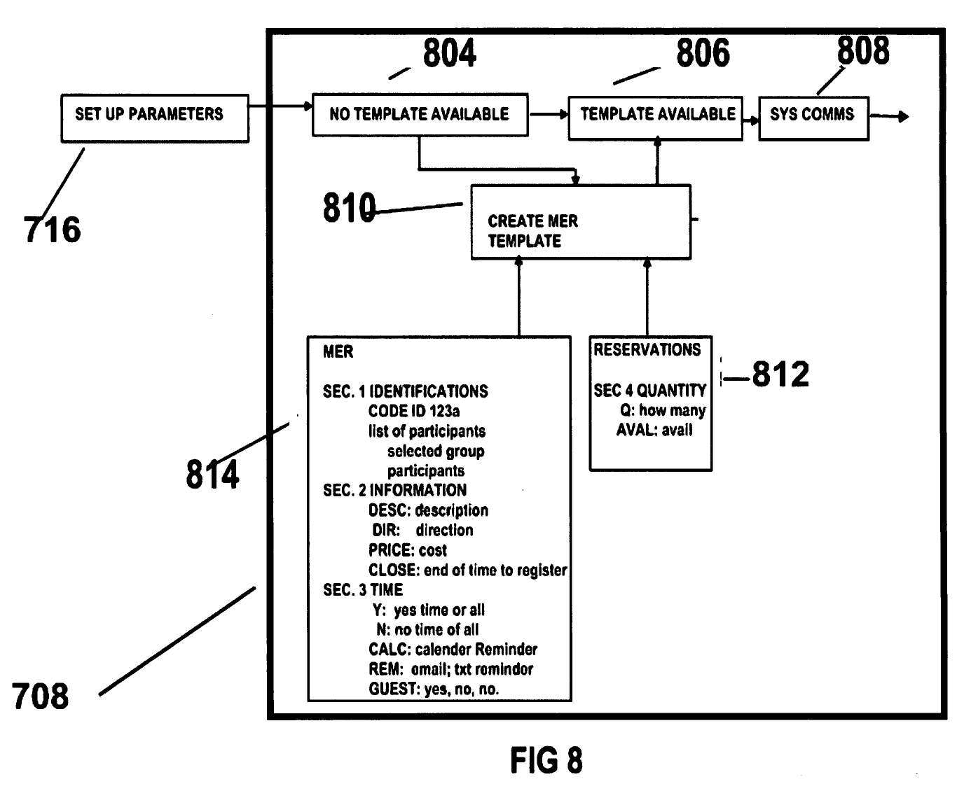

Consistent with method 400 (FIG. 4), method 500 (FIG. 5), and method 600 (FIG. 6) FIG. 8 step 708 includes determining if a template is available 804 and if one is available then populating the template with the MER information in file 814 and any reservation information in file 812. File 814 contains pre-defined terms in shorten/abbreviated context to represent a MER related action. Template 814 SEC. 1 and SEC. 2 represent by way of example administrative parameters. Template 814 SEC. 3 represents by way of example user input parameters. The administrator/organizer of the MER does not need to input all parameters. In one embodiment of the invention, if a parameter is missing the system 100 and method 400 (FIG. 4), method 500 (FIG. 5), and method 600 (FIG. 6), based upon one or more methodologies for evaluating likely missing information, and thereby fills in missing parameters. Such methods of evaluating likely missing information is well known by those or ordinary skill in the art of programming expert systems. If a template is not available 804 then the method includes creating a new template 814 and proceeding to populate it with the MER information in file 814 and any reservation information existing in file 812.

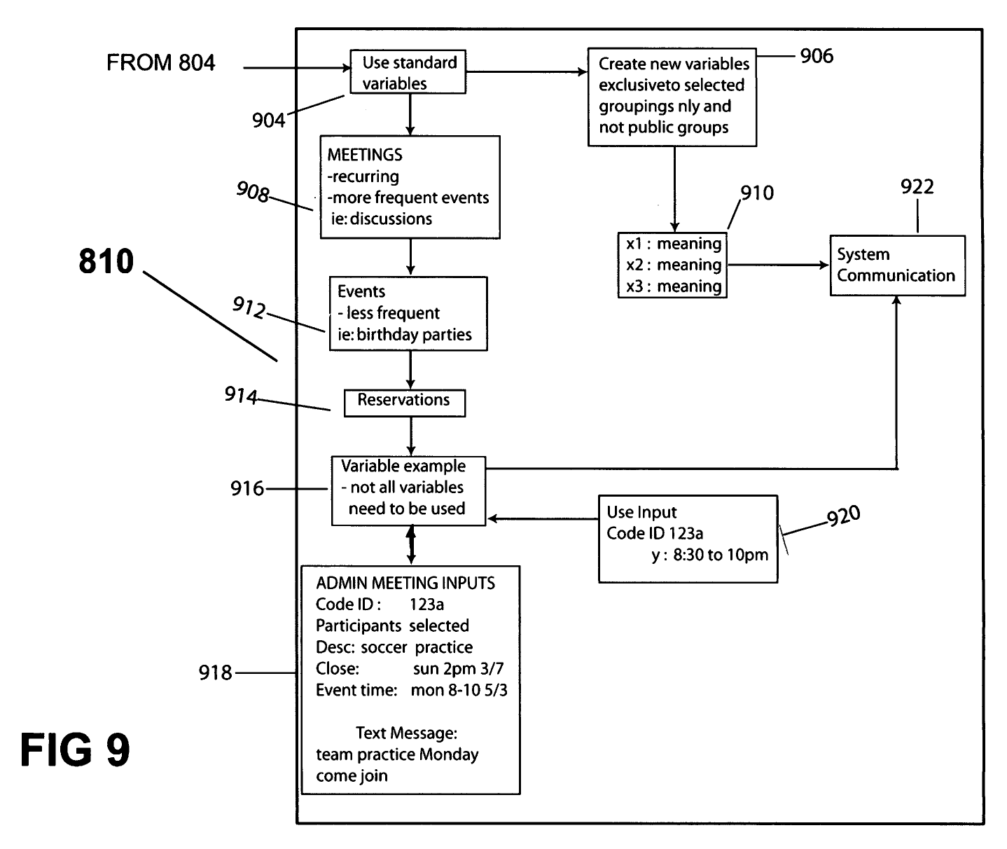

By way of example and not limitation, FIG. 9 illustrates the creation of a template. The administrator may use standard variables or create new variables commonly used or novel to calendaring. If the administrator chooses to use standard variables it selects from a meetings events file 908 by way of example and not limitation the type of event, recurrence frequency, end dates, etc. Other options are events file 912 that are less frequent, (i.e., birthdays). Still other options are the selection or reservations file 914.

Other variables that may be selected are administration meeting inputs 918 and user inputs 920. When the full set of events and variables have been chosen for the template it then placed into the system communication 922 for broadcast. If the administrator elects not to use the standard variables, it may created its own variables 906 by defining various variables to mean what is pertinent to the MER, but not within the standard accessible standard variable files, such as by way of example 908, 912 or 914

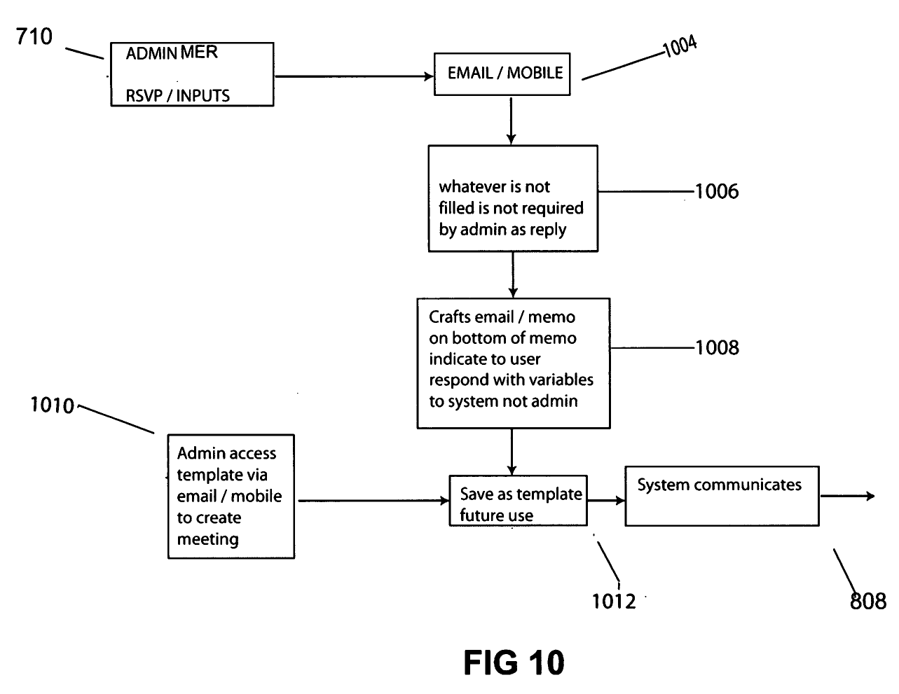

Consistent with method 400 (FIG. 4), method 500 (FIG. 5), and method 600 (FIG. 6) in FIG. 10, an administrator 1002 uses an email or mobile device 1004 to initiate the scheduling process. In step 1006 it uses a form to input the MER variables, by way of example, an email 1008. The variable input is combined in 1012 with a template 1010 obtained via email or mobile device to create the MER. The template is stored for future use and the MER is sent to system communication to be broadcast.

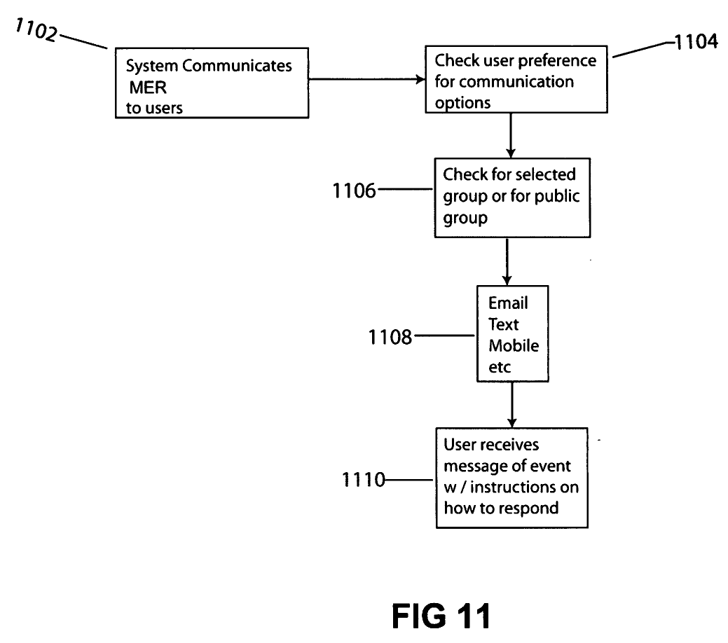

In FIG. 11, the system 100 communicates 1102 with invitees. The system 100 first checks user preferences 1104 for communication options as previously discussed, wherein preferences are stored by way of example in the web information services module 124 that associates a potential invitee to a given technology and communication application. The system 100 then checks if the broadcast is to a select group or a public broadcast 1106. The database 107 contains a roster of contacts, such that contacts and action identification will have the unique identifiers. If communication relates to a public event, anyone can join provided they respond to the scheduling with the action identification associated with the MER. The communication process is then completed 1108 by sending the MER schedule via any of the preferences as stored by way of example in the web information services module 124 that associates a potential invitee to a given technology and communication application. In step 1110 the invitee/user receives the message with instructions as to how to respond.

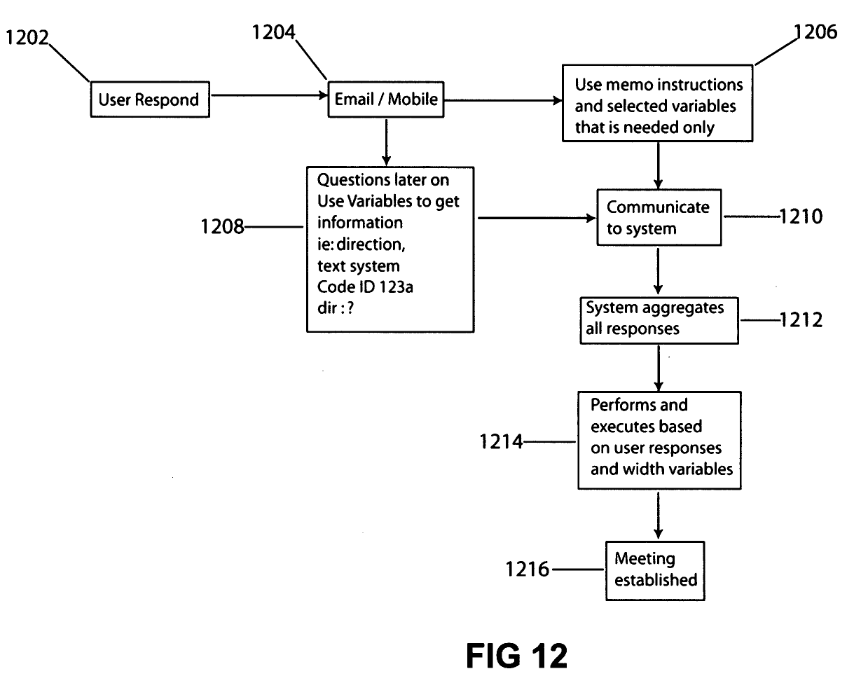

FIG. 12 illustrates in part the option a user has to respond to a MER. Consistent with method 400 (FIG. 4), method 500 (FIG. 5), and method 600 (FIG. 6) in FIG. 12, the invitee/user responds 1202 as by way of example via email or mobile 1204. By way of further example, the invitee/user may question regarding directions 1208 and then communication 1210 these questions to the system 100. The system 100 aggregates all responses from the invitees/users 1212. The system 100 then performs and executes based upon the invitee/user responses to establish the meeting 1216. In step 1206, a memo instruction and selects variables that are need by system 100 in aggregating the responses 1212. In 1204 the user can select the mode of response. If the user receives an MER from email and desires to respond through a txt message, it will need the MER ID and insure its contact is part of the invite list to identify its identity. Or the user can respond back to the invite using the same communication mode. In step 1206 are instructions and MER from the organizer. For first time users, this is helpful such that users know how to respond using the correct context for short hand commands. In step 1212 the system aggregates all responses and matches with the MER parameters. In step 1214 the system executes on commands of the MER. For example, update user's calendar's that were requested, email reminders, update users based on organizer's request, etc. 1216 meeting is confirmed based on established MER.

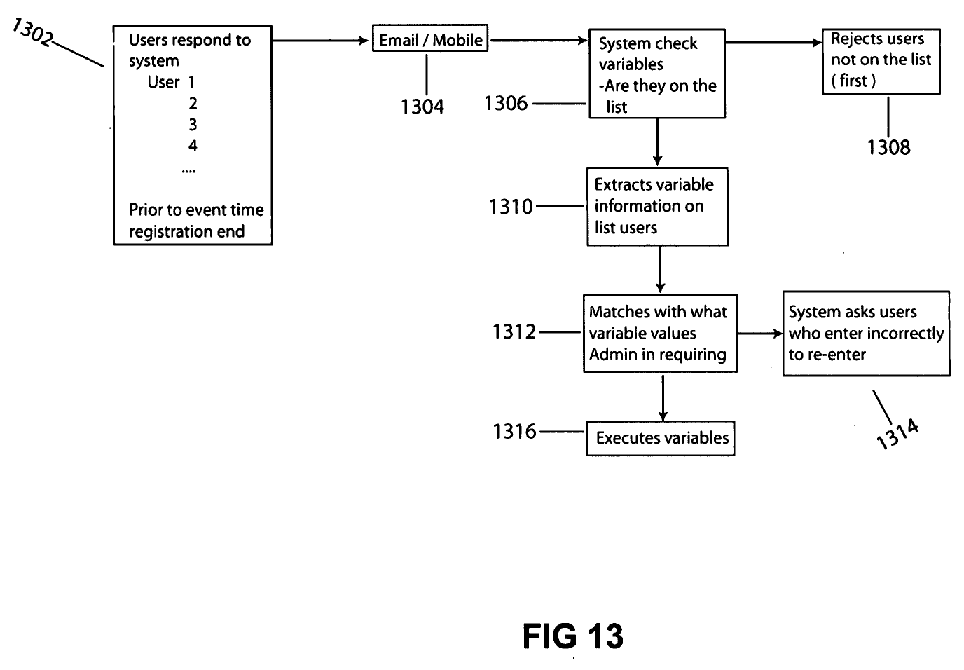

FIG. 13 is a flow chart of a method for setting up templates according to an embodiment of the present invention. In step 1302 one or more users respond to system 100 via email 1304 regarding a MER. The system 100 checks 1306 whether the variables are contained in the list pertaining to the particular MER. It checks 1308 if each user is on the list of authorized users and if not rejects and unauthorized user. The system extracts the variable information 1310 and matches the variable information resident in the system 100 relative to the particular MER. In step 1316 it executes on the variables contained therein. In the process of matching the information resident in the system 100 relative to the particular MER the system 100 may find that the user in 1302 did not include information or inputted incorrect information. In either of these events, the system may reply 1314 to the user to supply the missing or corrected information.

For purposes of explanation and not limitation, the system 100 and consistent with method 400 (FIG. 4), method 500 (FIG. 5), and method 600 (FIG. 6) includes a set of templates, variable data as to the particular MER that included in one or more of a communicated templates, data as to the addresses of the invitee/users, preferences as to the mode of communication, and standard information. As detailed in FIG. 4 through FIG. 14 the underlying feature is that an administrator creates a template for an event or action (i.e., a MER) that it wants to engage other invitee/users with. By way of further illustration, each such template contains variable data such as an event code. By way of example “event code: 123a” codes a place, time and date: Place: Outdoor tennis; Time: Tuesday 11-3 pm/Wednesday 4-7 pm/Thursday 2-5 pm; Date: Mar. 8, 2010.

Other variable codes may code for registration deadlines. Standard codes may relate to system 100 email, and system text phone numbers.

The administrator uses emails or text messaging to communicate the foregoing MER information. The system 100 logs the administrative information in a file according the event as will as other details related to administrative activity.

A reply by a typical invitee/user may be received by system 100 as follows by recipients of the MER communication. By way of example, John replies by txt, that includes the following: Code: 123a, Y: Tu 12-3, Rm: Y, Cal: y. John also sends Rm, a code that requests the system 100 to send a reminder. He also sends Cal: y, a code that requests that his calendar is updated by system 100. Bob replies by txt that includes the following: Code: 123a, Y: Tu 11-11:30 1-3. Tom replies by txt that includes the following: Code: 123a, Y: Tu 1:30-3. Jr emails reply by test that includes the following: Code: 123a, Y: Tu 1:30-3. Registration closes, the administrator views the file roster and determines that Tuesdays 1:30-3:00 pm is a time when all are available. A communication is generated by system 100 that the time is established as 1:30-3:00 pm. John gets a reminder and updated calendar.

In an example of sales, purchasing or inventory related applications, a hypothetical example may proceed as follows: An administrator creates a template for an event or action that it desires to engage people in. It identifies the MER in a code: Code: 123b and identifies the name of a product, price, and quantity. Other information may be coded that include additional product information, directions to a location, or persons to contact. By way of example: Example User 1 sends a request to the system 100 in a communication that includes Code: 123b, Prod: 1, Q: 2, Price: ? The communication is essentially requesting information price and quantity. The system 100 processes the request and replies: Prod: 1, Q: 2, Price: 4.95. In return the User 1 replies: Y: Y and the transaction is complete.

In yet another example, the administrator creates a template for an event or action that it wants to engage people in and creates a MER having an identification code Code: 123c; Pro: Name of product; Pri: $ dollar; and Q: Quantity. Additional information may include Cl: close date or time and Disc: XX % first N; where XX indicates a percentage discount and N equals the quantity to which the discount applies.

Using system 100 the administrator communicates the MER: Code: 123c, Pro: 1, Q: 100, Pri: 2.95, Cl: 4 hours. The User replies: Code: 123c, prod: 1, Q: 5. Here, the transaction completed with 5 products sold at 2.95.

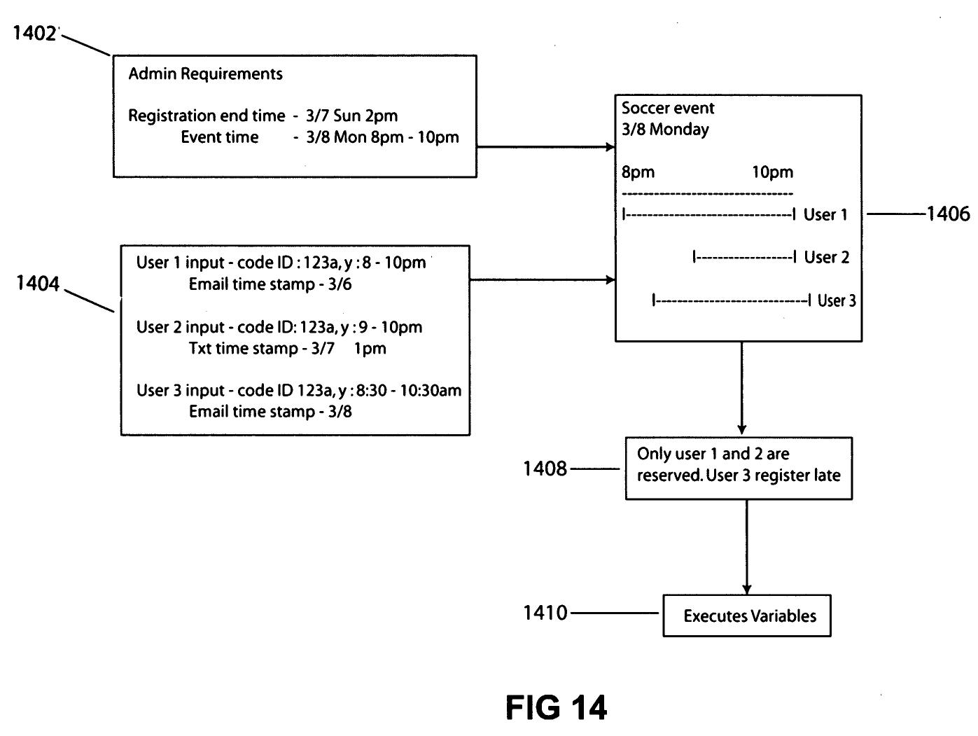

FIG. 14 illustrates three users each desirous of attending a soccer event 1406 Monday, March 8. The administrative requirements 1402 are indicate and input into the event 1406. In step 1404 each user responds to the scheduler with the times it will attend the event. However, only user 1,2 are scheduled because user 3 registered 1408 too late. The variables as relates to user 1,2 are executed in step 1410.

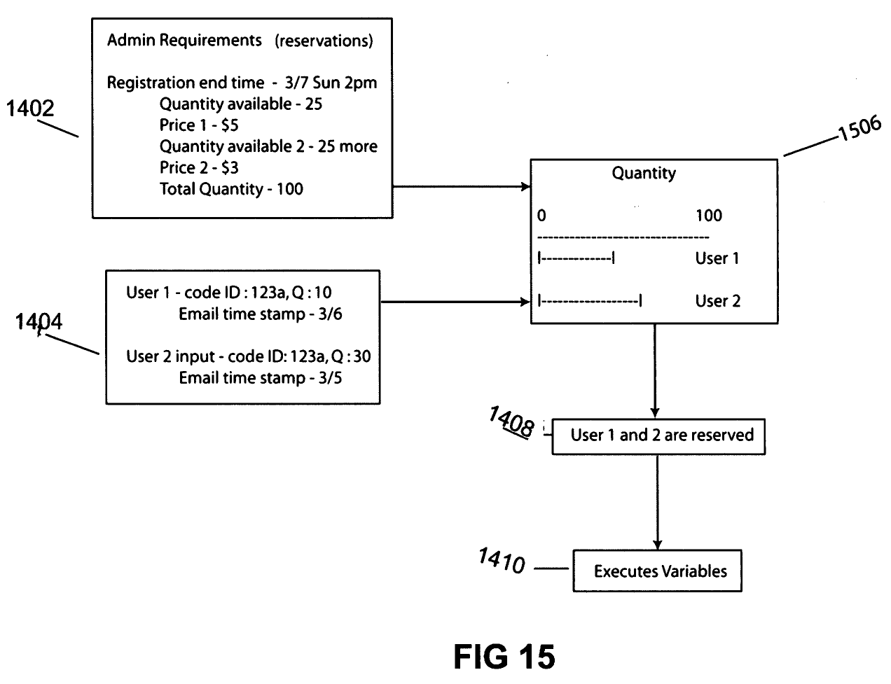

Similarly, by way of example in FIG. 15 an administrative requirement 1402 related to the purchase of a limited quantity of a commodity is desired by two potential purchasers 1404. Since both purchasers reserve there desired quantity within the time allotted, the quantities 1506 are thus reserved 1408. The system 100 thereby executes the variables 1410 to establish the necessary association between the purchasers (users 1, 2) and the quantities 1506 reserved 1408.

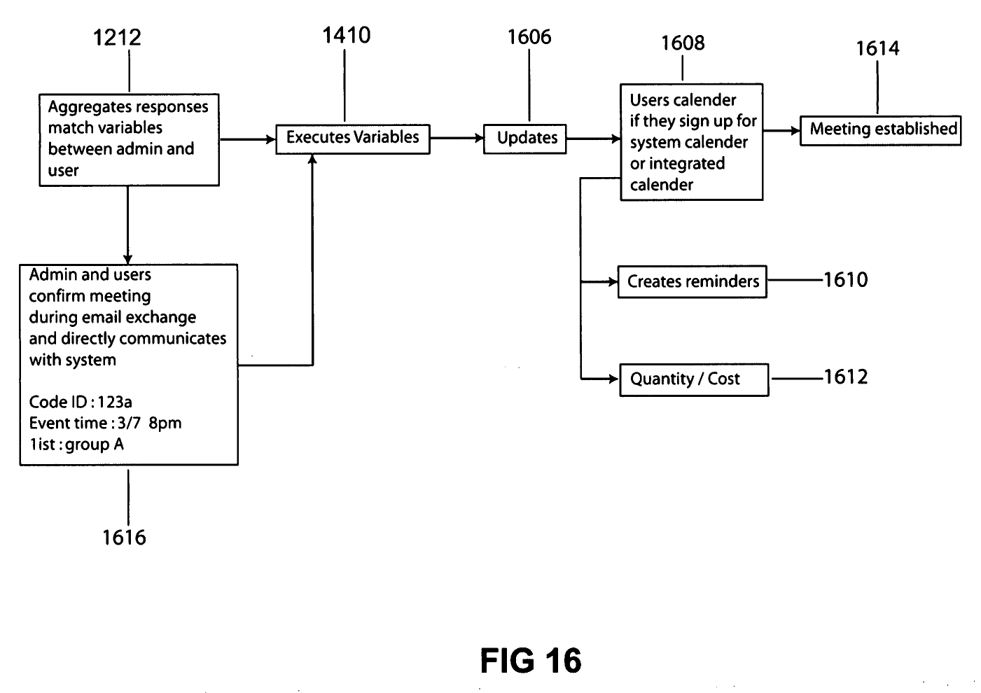

In FIG. 16 the system 100 aggregates responses 1212 as previously described in connection with FIG. 12. Following the aggregating of responses 1212, the administrators and invitee/users confirm meeting 1616 and this is combined to execute the variables 1410 as in FIG. 14. In step 1606 calendars 1608 are updated and the meeting 1614 is deemed established. System 100 has optional features of creating reminders 1610 and in the case of purchases emails or text messages detailing the quantities or cost of the items purchased 1612. If a user is registered it can create one or more calendars on the system 100 or integrate its calendar with other calendar applications. Additionally the user may be provided virtual calendar, as previously described, that is the MER is emailed per their request and updated. In yet another embodiment non-registered users with be provided virtual calendars.

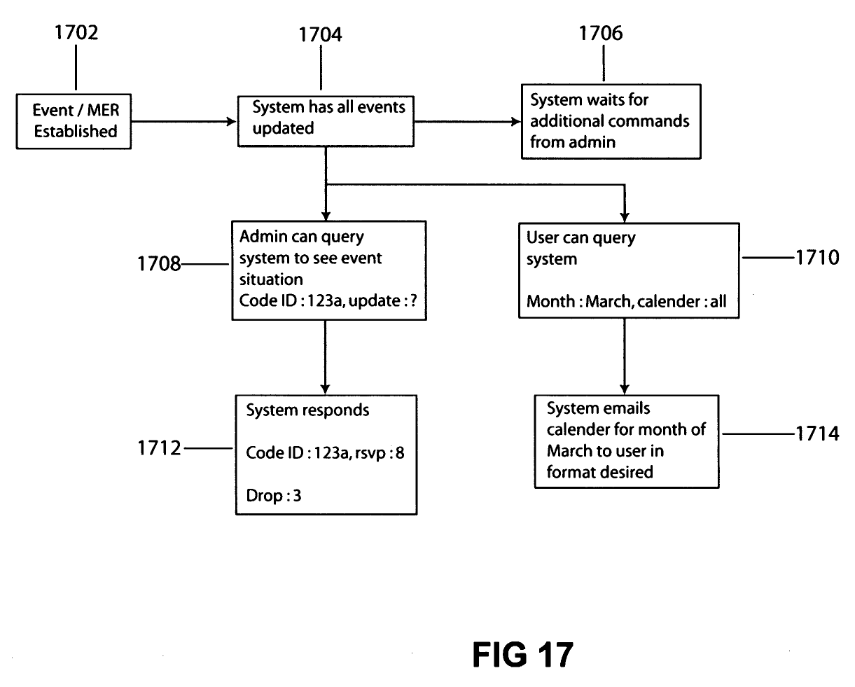

In FIG. 17, the system 100 has established the MER 1702 with its invitee/users and proceeds to update the all events 1702 it may have in its database 107 and awaits further input 1706 from the administrator. In one embodiment of the invention the administrator can query the system to display the events that are logged with the system. Additionally a user can query 1710 system 100 to view a calendar of the MER. Administrative queries are responded to 1712 and user queries are responded to 1714.

While the present invention has been described with reference to the illustrative embodiments, this description is not intended to be construed in a limiting sense. Various modifications of the illustrative embodiments, as well as other embodiments of the invention, will be apparent to those of ordinary skill in the art in reference to this description. It is therefore contemplated that the appended claims will cover any such modifications or embodiments as fall within the true scope of the invention.

What is claimed is:

1. A computer method for scheduling an event comprising: selecting a mode of communication compliant with an invitees receiving device; sending the invitees an event having one or more associated parameters based upon a template; and receiving availability from the invitees for each event having parameters; matching the event to the invitees availability for the event; automatically initiating the event by calendaring or booking to preserve the position at the event for the invitee.

2. The method of claim 1, further creating the template for the event.

3. The method of claim 1 wherein the template contains variable data about an event and standard data.

4. The method of claim 1 wherein creating the event is achieved autonomously.

5. The method of claim 1, further comprising establishing a communication with each invitee.

6. The method of claim 1, further comprising sending a notification to each invitee after obtaining a confirmation of an event booking.

7. The method of claim 5, wherein communication with an invitee is established is based upon context information that associates the invitee with a type of event.

8. The method of claim 1 wherein the template contains context information that associates the invitee with a type of event.

9. The method of claim 1, further comprising notifying each of the plurality of invitees of the date and time of the event via the mode of communication compliant with an invitees receiving device.

10. A machine readable storage, having stored thereon a computer program having a plurality of code sections executable by a machine for causing the machine to perform the steps of: creating a template having a conditional availability for each of a plurality of invitees to an event; selecting a mode of communication compliant with a receiving device of each invitee; sending the plurality of invitees a communication based upon the content of the template; and receiving availability from one or more of the invitees responding to be scheduled for the event; matching the event to the invitees specific availability for the event; automatically initiating the event by calendaring the position for the event for the invitee responding to be scheduled for the event.

11. The machine readable storage, having stored thereon a computer program code sections executable by a machine in claim 10, wherein the template contains pre-defined terms in abbreviated context to represent an the event.

12. The machine-readable storage, having stored thereon a computer program code sections executable by a machine in claim 10 further including the step of aggregating responses invitees responding to be scheduled for the event.

13. The machine-readable storage, having stored thereon a computer program code sections executable by a machine in claim 10 wherein the templates include variable data as to the particular event.

14. The machine-readable storage, having stored thereon a computer program code sections executable by a machine in claim 10 further including updating the calendar of invitees responding to be scheduled for the event.

15. The machine-readable storage, having stored thereon a computer program code sections executable by a machine in claim 10 further including reminding invitees responding to be scheduled for the event of the date and time of the event.

16. The machine-readable storage, having stored thereon a computer program code sections executable by a machine in claim 10 further including the step of determining the mode of communication for each of the invitees.

17. A computer system for scheduling an event comprising: a means for selecting a mode of communication compliant with an invitees receiving device; a means for sending the invitees an event having one or more associated parameters based upon a template; and a means for receiving availability from the invitees for each event having parameters; a means for matching the event to the invitees availability for the event; a means for automatically initiating the event by calendaring or booking to preserve the position at the event for the invitee.

18. A computer system for scheduling an event as in claim 17 further including a means for determining the mode of communication for each of the invitees.

19. A computer system for scheduling an event as in claim 17 further including a means for reminding invitees responding to be scheduled for the event of the date and time of the event.

20. A computer system for scheduling an event as in claim 17 further including a means for updating the calendar of invitees responding to be scheduled for the event.
